(19) United States
(12) Patent Application Publication
(10) Pub. No.: US 2016/0166957 A1
(43) Pub. Date: Jun. 16, 2016

(54) FILTER FASTENING SYSTEM

(71) Applicant: ORBITAL SYSTEMS AB, MALMÖ (SE)

(72) Inventor: Amir Mehrdad MAHDJOUBI NAMIN, MALMÖ (SE)

(73) Assignee: ORBITAL SYSTEMS AB, MALMÖ (SE)

(21) Appl. No.: 14/908,800

(22) PCT Filed: Jul. 16, 2014
(86) PCT No.: PCT/SE2014/050894

§ 371 Date: Jan. 29, 2016

(30) Foreign Application Priority Data
Aug. 1, 2013 (SE) 1350924-5

(51) Int. Cl. B01D 35/30

(52) U.S. Cl. CPC B01D 35/30

(57) ABSTRACT

The present invention describes a filter fastening system 1 comprising a filter socket 2 and a filter locking unit 3, wherein the filter socket 2 has a first end 4 being a top end and a second end 5 being a bottom end and a longitudinal body 6, wherein the filter locking unit 3 comprises a locking arm 7 with a connection end 8 and a locking end 9, a stopper 10 and a connection 11 where the connection end 8 of the locking arm is fixated with a joint 12 so that the locking arm 7 is pivotably arranged in the filter fastening system 1 so that the filter socket 2 may be fastened by pivoting the locking arm 7 until the bottom end 5 of the filter socket 2 is tightened against the stopper 10 and the top end 4 hence is tightened and sealed against a water piping connection for the filter socket (2).

### FIELD OF THE INVENTION

The present invention relates to a filter fastening system.

### TECHNICAL BACKGROUND

There exist many types of water filters today. Common with most of them is related to the way they are incorporated and the way of replacing consumed such filters.

One aim of the present invention is to provide a filter fastening system exhibiting high filter efficiency and at the same time high usability with reference to the possibility of replacing a consumed filter intended to be discarded, possibility of incorporating added features, etc.

### SUMMARY OF THE INVENTION

The purpose above is achieved by a filter fastening system comprising a filter socket and a filter locking unit, wherein the filter socket has a first end being a top end and a second end being a bottom end and a longitudinal body, wherein the filter locking unit comprises a locking arm with a connection end and a locking end, a stopper and a connection where the connection end of the locking arm is fixated with a joint so that the locking arm is pivotably arranged in the filter fastening system so that the filter socket may be fastened by pivoting the locking arm until the bottom end of the filter socket is tightened against the stopper and the top end hence is tightened and sealed against a water piping connection for the filter socket.

With reference to above, the longitudinal body is the jacket of the filter socket. Furthermore, it should also be said that during use, the filter socket/filter housing of course contains a filter. This filter may be of different types, which fact is further explained below in relation to the drawings. It may further be said that the filter socket may comprise the filter housing so that they can be regarded as separate units, but they may also be one and the same unit according to the present invention. As such, the latter case, when they are one and the same unit, is one specific embodiment according to the present invention.

It should further be said that the design of different units of the system may vary, e.g. with reference to the length of the filter socket and matching locking unit.

The design and construction of the filter fastening system according to the present invention has several advantages. The main purposes are directed to providing a suitable filter system for water recycling applications, said system providing so high usability so that anyone may replace a consumed filter with a new one very quickly and easily. This is not the case with existing filter systems of today, which either is intended for installation and filter replacement to be performed by a plumber or the Ike or which has several time-consuming and difficult moments such as lifting the bottom part of the filter while at the same time using a sealing key to ensure a tight and sealed arrangement. This latter moment is also quite hard, which excludes the possibility for large part of the population. The filter socket holding a filter cartridge to use according to the present invention, however, may be replaced by use of only one hand and very quickly (about 10 seconds). The design of a filter socket/filter house holding a cartridge in one and the same complex according to the present invention provides for this advantage. It may once again be mentioned that the entire filter unit according to the present invention may be only one unit as a whole, i.e. filter socket and filter cartridge is the one same unit.

Moreover, in addition to the aesthetic design, there are also other advantages with a filter socket covering the filter bottle. As heat insulating properties may be of interest when recovering e.g. shower water in a shower system, this due to keeping the heat of the water during the purification and recirculation cycle, the filter socket may be provided with such a material. Also a material exhibiting heat conducting properties may be of interest for the filter socket.

One great advantage of the filter fastening system according to the present invention is related to the possibility of incorporating horizontal filter sockets and hence filters, which is not the normal case having vertical filters instead. The horizontal design according to the present invention allows for a smaller and more versatile product, e.g. in relation to incorporating the system into comparatively narrow spaces, and also enables a simple procedure for replacing a consumed filter with a new one in such narrow spaces. Standard filter housing used today being vertically arranged may not be used in such narrow spaces, such as e.g. in showers having water recycling where this water purification and recycling system has to be tight and not space consuming. If a standard filter is incorporated into such a system, the space needed would be very large and the filter replacement procedure difficult and time-consuming. This is not the case with the filter fastening system according to the present invention, which solves both these problems.

### BRIEF DESCRIPTION OF THE DRAWINGS

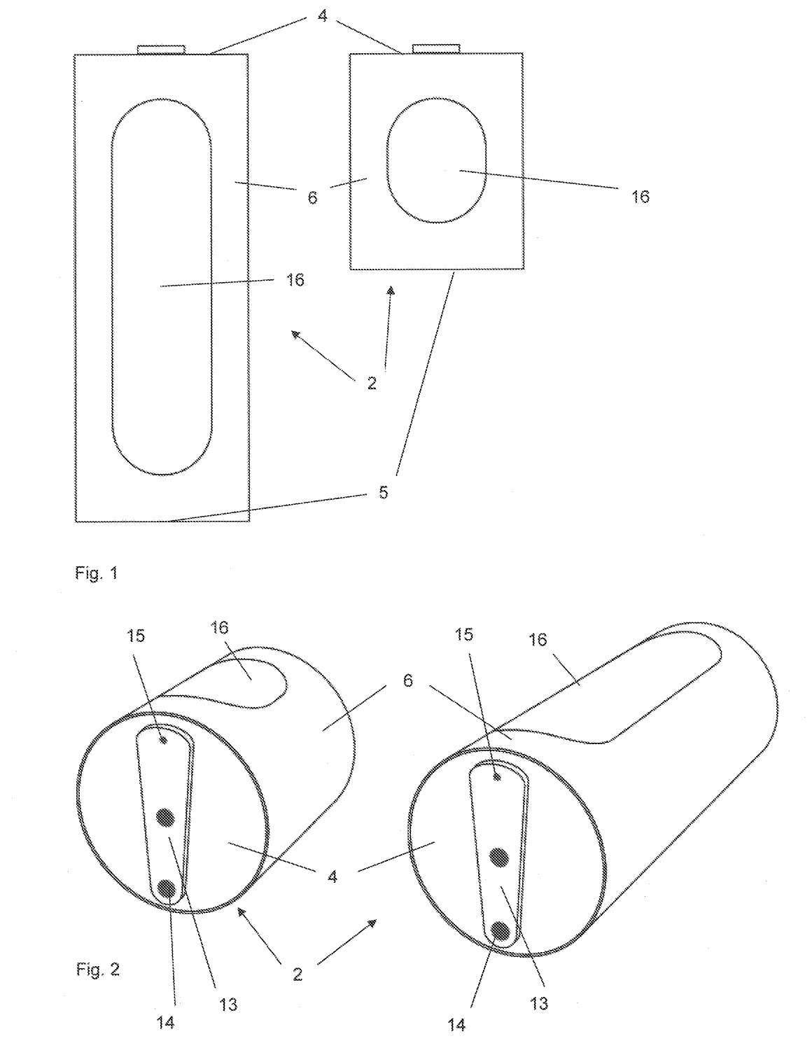

In FIG. 1 there is shown a front view of two filter sockets according to one embodiment of the present invention, the two filter sockets having different size.

In FIG. 2 there is shown the two filter sockets lying, seen from above and aslant from the side.

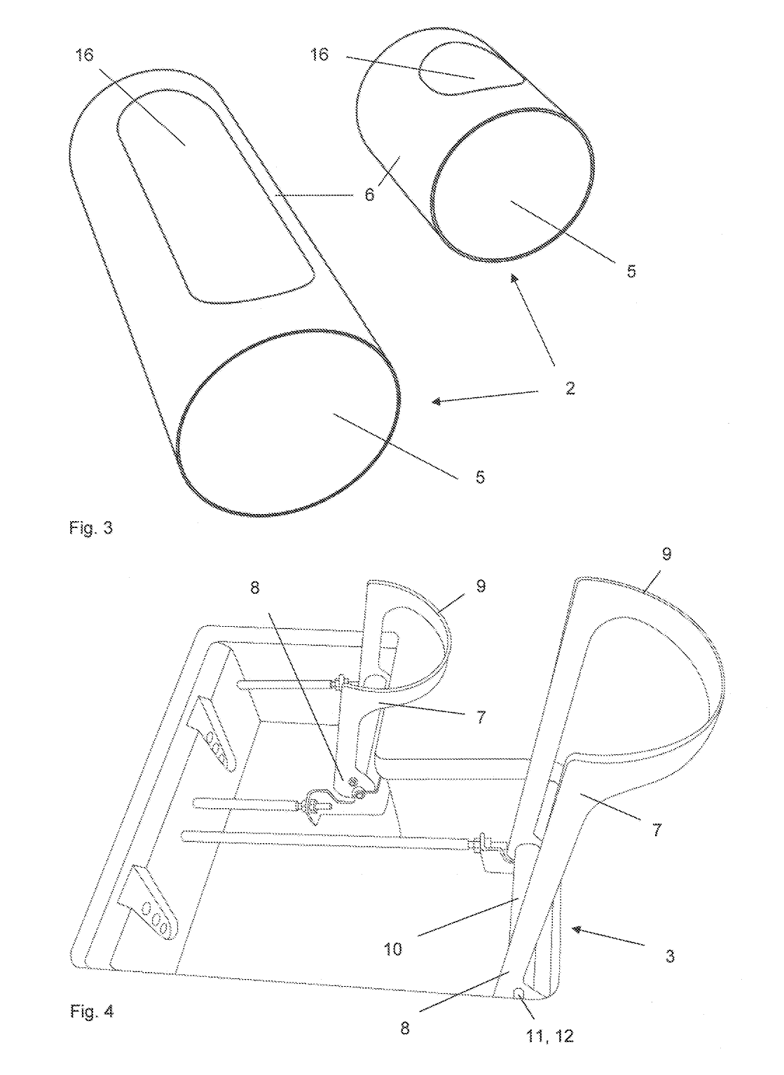

In FIG. 3 there is shown the two filter sockets lying, seen from below and aslant from the side.

In FIG. 4 there is shown a filter fastening system according to the present invention, comprising a filter locking unit according to one specific embodiment.

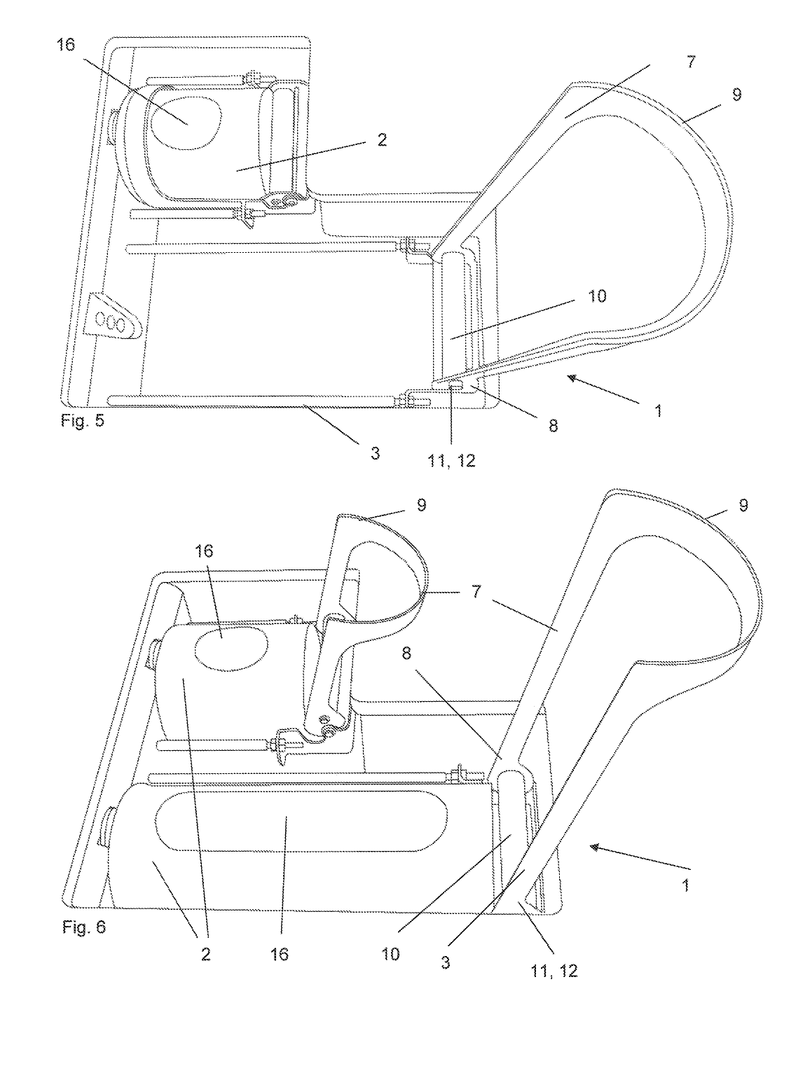

In FIG. 5 there is shown a filter fastening system like the one shown in FIG. 4, however in this case one filter socket containing a filter housing with a filter is locked into the system. The filter socket and filter housing may be regarded as the same one unit.

In FIG. 6 there is also shown a filter fastening system like in FIG. 4 and FIG. 5, and in this case having two filter sockets containing two different types of filters.

### SPECIFIC EMBODIMENTS OF THE INVENTION

Below some specific embodiments of the present invention are described. According to one specific embodiment of the present invention, the locking end of the locking arm has a shape matching the longitudinal body of the filter socket. According to yet another embodiment, the filter socket may be fastened by pivoting the locking arm until the locking end of the locking arm touches the longitudinal body of the filter socket.

According to one embodiment, the filter socket is cylindrical and the locking end of the locking arm is bent to match the longitudinal body of the filter socket. In this case the locking end of the locking arm may also be said to be concave. According to yet another embodiment, the locking arm is an eccentric lever.

According to yet another specific embodiment, the top end of the filter socket is provided with a top packing having through holes for both inflow and outflow. The through holes are openings intended to be connected to piping in a system so that water inflow to the filter as well as water outflow from the filter may be implemented. The top packing may be arranged in or on top of a top head or cylinder head. It is important that also this top head must allow the inflow and outflow of water.

The design according to above implies that the filter housing according to the present invention has a connection port or interface where all of the inlets and outlets are arranged in one and the same surface. This provides an advantage as the entire filter housing may be viewed as a male connection which is to be connected with a female connection of the system in which the filter is to be incorporated. The entire filter replacement is simplified as no sealing of the filter housing is needed, which is needed with standard filters of today. Furthermore, the sealing during normal operation is also improved as sealing is only needed of the one and the same surface. With the filter fastening system according to the present invention this is accomplished in an effective way, i.e. by use of the locking arm and without the need of additional tools. Such tools, like a locking key, are otherwise needed when standard water filters are sealed.

Moreover, the packing may e.g. be of a material like rubber, e.g. ethylene propylene diene monomer (EPDM) rubber or Viton®. Furthermore, the shape of the connection interface may vary, such as e.g. oval or oval and

V-shaped such as shown in the figures. The V-shape may be an additional feature to ensure that it is not possible for the user to connect the filter house in a wrong manner upside down.

Furthermore, according to one embodiment, the top packing also has a ventilating through hole. This design according to the present invention allows for ventilating to be made in an easy way when the filter fastening system is installed in e.g. a water purification system, such as for instance a shower system having water purification and recirculation. As this may be performed efficiently, there is no risk that air bubbles are situated inside of the filter. Such air bubbles reduce the filter area that is used, which in turn reduce the durability and filter life. Fact is that the filter fastening system according to the present invention allows for automatic ventilating, which is not the case with a standard filter.

The filter fastening system according to the present invention may also be provided with additional features. According to one embodiment, the filter socket is provided with at least one inspection window on the longitudinal body of the filter socket. The inspection window may of course have different shape and size. Moreover, the filter socket may also be provided with several inspection windows on the longitudinal body, such as e.g. two exactly the same situated on opposite sides of the longitudinal body.

An inspection window may allow for several advantages, such as the possibility of viewing the entire filter, such as for finding undesired damages of the filter or noticing unusual substances or particles stuck in the filter, the possibility of exposing the filter and the filter housing content to external influence, e.g. disinfection radiation, such as from an UV lamp, to kill any living particles or bacteria, and also proving an effective indication system, such as lamps showing if the filter is operating as intended (lamp showing green light) or if the filter is consumed (lamp showing red light, e.g. with flashing effect) and therefore should be replaced. Furthermore, the filter fastening system and filter sockets and contained filters may be provided with locks and keys, some type of encryption or other form of recognition or identification system. This may be of interest to ensure that the wrong type of filter sockets and filters cannot be used in the filter fastening system. Also this feature may be linked to lamps showing only a green light when the right type of filter socket and filter is locked into the system and is good to go, i.e. not consumed.

According to yet another specific embodiment, filter socket is provided with at least one diode or lamp. Several diodes may be arranged in the filter fastening system. As mentioned above, the diodes or lamps are e.g. intended to indicate when the filter is consumed and must be replaced, but different diodes may be connected to different types of sensors reacting on different parameters.

Furthermore, according to another embodiment, the filter fastening system is provided with an UV lamp. Such an UV lamp may be provided to allow for disinfection, such as mentioned above.

### DETAILED DESCRIPTION OF THE DRAWINGS

In FIG. 1 there is shown a front view of two filter sockets 2 according to one embodiment of the present invention. The two filter sockets 2 have different size. Both of them have a first end 4 being a top end and a second end 5 being a bottom end, and a longitudinal body 6. Furthermore, both of them have inspection windows 16 of different size and shape. In both cases, two inspection windows 16 of exactly the same size and shape are arranged on opposite sides of the longitudinal bodies 6.

In relation to the present invention it may further be said that the filter socket 2 and its filter housing/filter are designed to manage suitable water pressures for different types of such applications, such as for showers where water purification and recirculation are incorporated.

In FIG. 2 there is shown the two filter sockets 2 lying, seen from above and aslant from the side. On the top end 4 there is provided an oval V-shaped top packing 13, being a part of the connection interface, through holes 14 for both inflow and outflow, and in this case there is also provided a ventilating through hole 15.

In FIG. 3 there is shown the two filter sockets 2 lying, seen from below and aslant from the side.

In FIG. 4 there is shown a filter fastening system 1 according to one specific embodiment of the present invention. The filter fastening system 1 has a filter locking unit 3 comprises a locking arm 7 with a connection end 8 and a locking end 9, a stopper 10 and a connection 11 where the connection end 8 of the locking arm 7 is fixated with a joint 12 so that the locking arm 7 is pivotably arranged in the filter fastening system 1. As may be seen, the filter fastening system 1 has a frame work in which the locking arm 7 is fixated. The left and right longitudinal arms of the filter locking unit 3, which arms are fixated in the frame work and not pivotable, are shown in the figure, but may also be covered by the plastic frame work. In relation to the filter fastening system 1 shown in FIG. 4 it should be mentioned that the actual locking arm 7 does not have to be arranged behind the filter socket 2 intended to be locked into the system 1. Fact is that such a locking arm 7 may also be provided to lock the filter socket 2 from the side instead. In such a case the shape of the locking arm gripping around the filter socket 2 is of course designed to be suitable for such an arrangement.

In FIG. 5 there is shown a filter fastening system 1 like in FIG. 4, however in this case one filter socket 2 containing a filter housing with a filter is locked into the system 1. The filter socket 2 is provided with inspection windows 16 on opposite sides of the filter socket 2. The filter in this case is a pre-filter typically being a standard filter, such as nylon filters or yarn-wound filters or e.g. activated carbon filters or UV-filters, intended to capture large particles in the water flow. Many different types of filters are possible.

In FIG. 6 there is also shown a filter fastening system 1 like in FIG. 4 and FIG. 5, and in this case two filter sockets 2 containing two different types of filters, none of them being locked into the system yet. The smaller filter socket 2 has a pre-filter, but the larger filter socket 2 has another type of filter in this case. The filter shown is a more advanced filter, a so called nano-filter, i.e. a filter being able to capture also very small structures below 100 nm. Also a nano-filter may be of different types, such as for instance an electropositive nano-ceramic filter, or another type. One advantage with the set-up disclosed in FIG. 6, i.e. with a pre-filter and a nano-filter, is a lengthened lifetime of the often more expensive nano-filter when compared to the pre-filter. It should be said that the present invention is not limited to a framework with two filters, fact is that also only one filter may be used. Moreover, the actual filter or filters incorporated may be of any type available, and the intended application should set the boundaries for the choice. When incorporating the filter fastening system 1 in a shower, the set-up shown in FIG. 6 is very suitable, i.e. having a first pre-filter and then a nano-filter.

1. A filter fastening system comprising a filter socket and a filter locking unit, wherein the filter socket has a first end being a top end and a second end being a bottom end and a longitudinal body, wherein the filter locking unit comprises a locking arm with a connection end and a locking end, a stopper and a connection where the connection end of the locking arm is fixated with a joint so that the locking arm is pivotably arranged in the filter fastening system so that the filter socket may be fastened by pivoting the locking arm until the bottom end of the filter socket is tightened against the stopper and the top end hence is tightened and sealed against a water piping connection for the filter socket.

2. The filter fastening system according to claim 1, wherein the locking end of the locking arm has a shape matching the longitudinal body of the filter socket.

3. The filter fastening system according to claim 1, wherein the filter socket may be fastened by pivoting the locking arm until the locking end of the locking arm touches the longitudinal body of the filter socket.

4. The filter fastening system according to claim 1, wherein the filter socket is cylindrical and the locking end of the locking arm is bent to match the longitudinal body of the filter socket.

5. The filter fastening system according to claim 1, wherein the locking arm is an eccentric lever.

6. The filter fastening system according to claim 1, wherein the top end of the filter socket is provided with a top packing having through holes for both inflow and outflow.

7. The filter fastening system according to claim 6, wherein the top packing also has a ventilating through hole.

8. The filter fastening system according to claim 1, wherein the filter socket is provided with at least one inspection window on the longitudinal body of the filter socket.

9. The filter fastening system according to claim 1, wherein the filter socket is provided with at least one diode.

10. The filter fastening system according to claim 1, wherein the filter fastening system is provided with an UV lamp.
